(19) United States
(12) Patent Application Publication
(10) Pub. No.: US 2007/0116263 A1
(43) Pub. Date: May 24, 2007

(54) PORTABLE COMMUNICATION APPARATUS AND METHOD FOR USING THE SAME

(76) Inventor: Tzu-Che Hsueh, Tainan, (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,157

(22) Filed: Jul. 3, 2006

(30) Foreign Application Priority Data
Jul. 1, 2005 (TW) 94122478

(51) Int. Cl. H04M 1/00

(52) U.S. Cl. 379/433.01

(57) ABSTRACT

The invention is directed to a portable communication apparatus. The portable communication apparatus comprises a communication main body, a keypad, an arrow keypad and a display screen. The keypad has at least one key disposed on the communication main body and the arrow keypad has keys disposed on the communication main body. Various characters are represented by combinations of the at least one key of the keypad with the keys of the arrow keypad. Furthermore, the display screen is disposed on the communication main body.

### CROSS-REFERENCE TO RELATED APPLICATION

This application claims the priority benefit of Taiwan application serial no. 94122478, filed on Jul. 1, 2005. All disclosure of the Taiwan application is incorporated herein by reference.

### BACKGROUND OF THE INVENTION

1. Field of Invention

The present invention relates to a portable communication apparatus and a method for using the same. More particularly, the present invention relates to a character input method by using at least one key and one arrow key to transmit at least one character to an editorial table as a character input operation for decreasing the number of the keys and saving space consumption.

2. Description of Related Art

The current message transmission speed is faster than ever even for the communication transmission. The distance between the individuals is not limited to the space because of the high development of the portable phone market. Even apart from each other for a long distance, the transmitter can transmit intentions and ideas to the receiver through a phone call.

Moreover, because the portable phones are frequently used, people not only orally communicate with each other through the portable phones but also transmit intentions and ideas through the short messages. Therefore, whether the text input method is handy or not becomes one of the key points for the user to select a proper portable phone.

As for the conventional portable phone, as shown in FIG. 1 which shows a main structure of the conventional portable phone, the input method for the conventional portable phone comprises steps of inputting a character using input keypads 12 after choosing the function menu within the phone main body 11 and then displaying the content of the input characters 14 through the screen 13. Alternatively, as shown in FIG. 2 which schematically shows the input keypad of the conventional portable phone, the input keypad 12 further comprises twelve operation keys and each operation key includes at least three characters. When the user inputs the characters, the user needs to repeatedly press the same key to choose a proper character. Therefore, it takes the user a lot of time to repeatedly press the keys of the input keypad 12 for a text and it wastes a lot of phone space for configuring the input keypad 12 as well. Hence, not only the input keypad 12 wastes a lot of space of the portable phone but also the character input method is time-consuming and is not convenient for the user. FIG. 3 is a flow chart showing the character input method for the conventional portable phone. The method is started at S31 and then a function menu in the portable phone is opened at S32. Thereafter, at S33, one of the options in the function menu is selected and the character input is performed. In S34, the character input is accomplished by selecting one input key in the portable phone for inputting a character in the function menu (S35). However, the message the user wants to transmit need to be done by repeatedly pressing the input keypads to reach the right characters for being input. It takes the user a lot of time to input a character for finishing the character input operation (S36). Finally, in S37, the character input operation is terminated and the function menu is closed.

According to the disadvantages of the character input for the conventional portable phone, the present invention provides a portable communication apparatus and a method for inputting characters by using at least one key and one arrow key to transmit at least one character to an editorial table as a character input operation for saving space consumption of the portable phone and increasing the user input speed.

### SUMMARY OF THE INVENTION

Accordingly, at least one objective of the present invention is to provide a portable communication apparatus capable of saving space of the portable communication apparatus for disposing keys.

At least another objective of the present invention is to provide a character input method for a portable communication apparatus capable of increasing the character input speed.

To achieve these and other advantages and in accordance with the purpose of the invention, as embodied and broadly described herein, the invention provides a portable communication apparatus. The portable communication apparatus comprises a communication main body, a keypad, an arrow keypad and a display screen. The keypad has at least one key disposed on the communication main body and the arrow keypad has keys disposed on the communication main body. Various characters are represented respectively by combinations of the at least one key of the keypad with the keys of the arrow keypad. Furthermore, the display screen is disposed on the communication main body.

According to one embodiment of the present invention, the characters include letters of an alphabet characters.

According to one embodiment of the present invention, the arrow keypad comprises a central key and four arrow keys.

According to one embodiment of the present invention, the arrow keys are directed in different directions.

The present invention further provides a character input method for a portable communication apparatus, wherein the portable communication apparatus has a keypad and an arrow keypad thereon. The method comprises steps of depressing the at least one key of the keypad and depressing one of the keys of the arrow keypad to select and input one of the items as a character into an editorial table of the portable communication apparatus.

According to one embodiment of the present invention, the character can be a letter of an alphabet character.

According to one embodiment of the present invention, various characters are represented respectively by combinations of the at least one key of the keypad with the keys of the arrow keypad.

In the present invention, since various characters can be represented by the combinations of the at least one key of the keypad on the portable communication apparatus with the keys of the arrow keypad on the portable communication apparatus, the character input method is simpler than that of the conventional portable phone. That is, the character can be input by simply press one key of the keypad together with one key of the arrow keypad and the user does not need to repeatedly press the same key for choosing only one character. Therefore, the character input speed can be increased. In addition, the space of the portable communication apparatus for disposing the keys can be saved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing showing a main structure of a conventional portable phone.

FIG. 2 is a schematic drawing showing the input keypad of a conventional portable phone.

FIG. 3 is a flow chart showing the character input method of the conventional portable phone.

FIG. 4 is a schematic drawing showing a portable communication apparatus according to one embodiment of the present invention.

FIG. 5 is a schematic drawing showing the editorial table of the portable communication apparatus according to one embodiment of the present invention.

FIG. 6 is a schematic drawing showing the combinations of keys of the portable communication apparatus according to one embodiment of the present invention.

FIG. 7 is a correspondence table illustrating the mapping of the combinations of keys of the portable communication apparatus.

FIG. 8 is a flow chart illustrating a character input method according to one embodiment of the present invention.

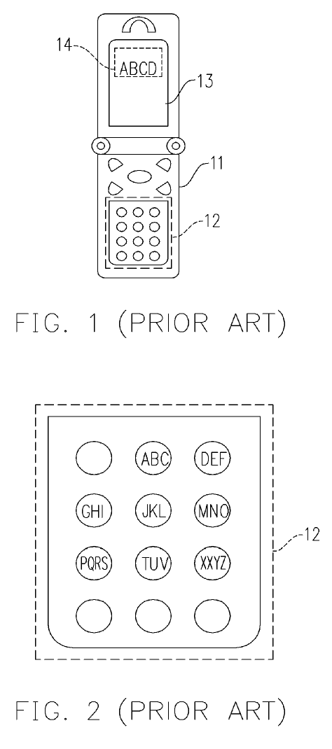

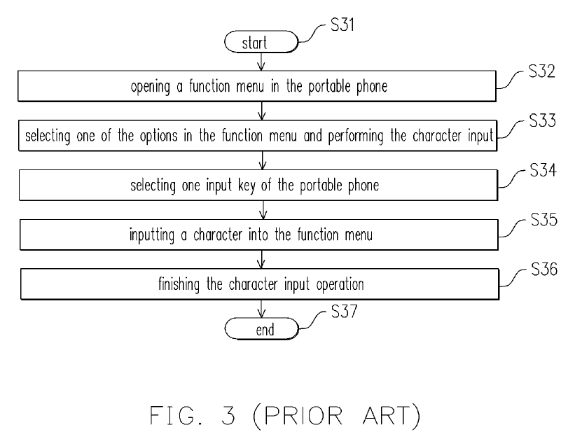

### DESCRIPTION OF THE PREFERRED EMBODIMENTS

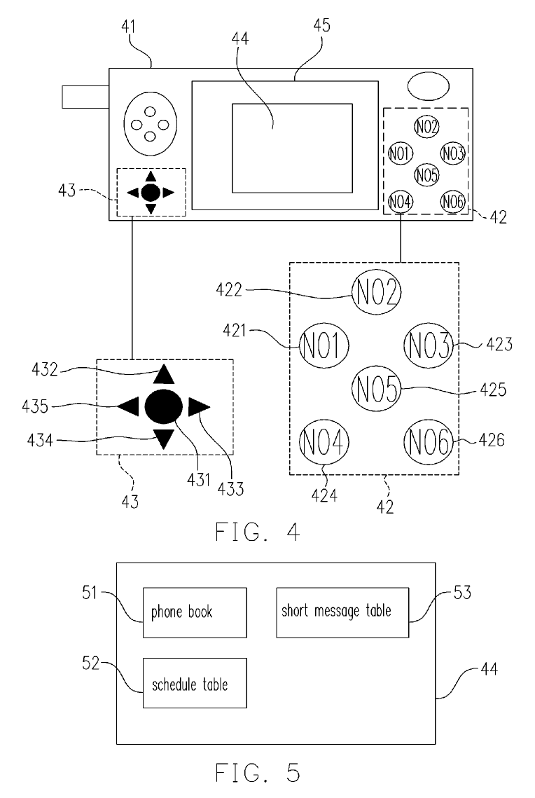

FIG. 4 is a schematic drawing showing a portable communication apparatus according to one embodiment of the present invention. As shown in FIG. 4, the portable communication apparatus comprises a communication main body 41 having at least one keypad 42 and one arrow keypad 43. The keypad 42 further comprises six keys including an NO1 key labeled 421, an NO2 key labeled 422, an NO3 key labeled 423, an NO4 key labeled 424, an NO5 key labeled 425 and an NO6 key labeled 426. Further, the arrow keypad 43 comprises a central key 431 and four arrow keys labeled 432, 433,434 and 435 respectively. The four arrow keys are directed in four different directions. More specially, the arrow key 432 and the arrow key 434 are directed in opposite directions. Similarly, the arrow key 433 and the arrow key 435 are directed in opposite directions. Preferably, the arrow key 432 is directed in a direction perpendicular to the directions where the arrow keys 433 and 435 are directed. Also, the arrow key 434 is directed in a direction perpendicular to the directions where the arrow keys 433 and 435 are directed. By using the arrow keypad 43 incorporating with the aforementioned six keys, the wanted character can be selected and the character can be, for example, a letter of an alphabet. Furthermore, an editorial table 44 is shown on a display screen 45 of the communication main body 41. The character input operation can be accomplished by inputting at least one character into the editorial table 44.

FIG. 5 is a schematic drawing showing the editorial table of the portable communication apparatus according to one embodiment of the present invention. As shown in FIG. 5, the editorial table 44 for editing the input characters further comprises a phone book 51, a schedule table 52 and a short message table 53.

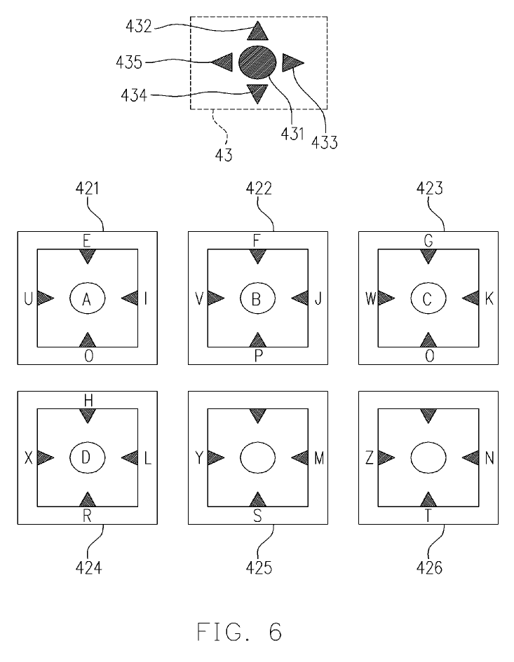

FIG. 6 is a schematic drawing showing the combinations of keys of the portable communication apparatus according to one embodiment of the present invention. As shown in FIG. 6, the arrow keypad 43 comprises five keys including the central key 431 and four arrow keys 432, 433, 434 and 435. The input method can be done by using the keypad 42 including the key NO1 421, the key NO2 422, the key NO3 423, the key NO4 424 and the key NO5 425 incorporating with the arrow keypad 43 having five keys for choosing one character so as to perform the character editorial input. Therefore, the user can increase the input speed.

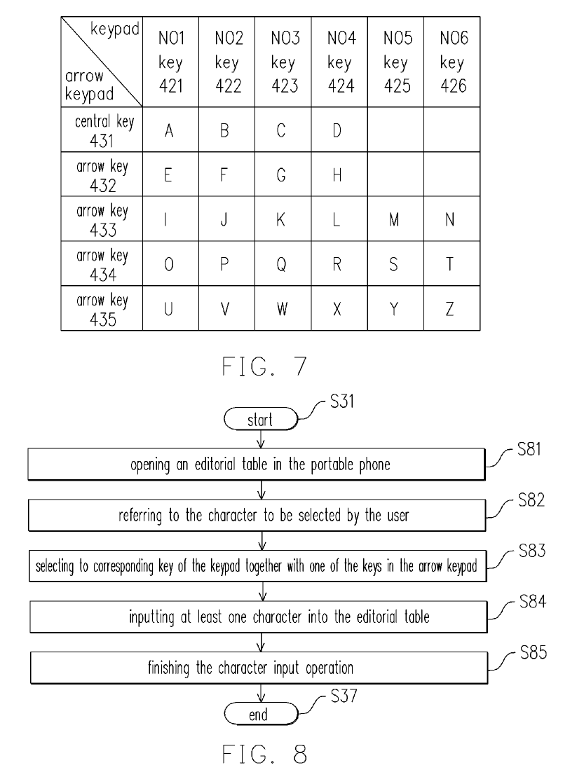

FIG. 7 is a correspondence table illustrating the mapping of the combinations of keys of the portable communication apparatus. As shown in FIG. 7, by properly combining the keys of the keypad 42 with the central key or the arrow keys of the arrow keypad 43, the user can easily choose a character for editing the short message. That is, various characters can be represented respectively by the various combinations of the at least one key of the keypad 42 with the keys of the arrow keypad 43. Taking the alphabet letters as an example, as shown in FIG. 6 and FIG. 7, when the user presses the key NO2 422 together with the arrow key 432, an alphabet letter “F” is chosen. According to this input method for inputting characters, not only the number of the keys of the keypad 42 can be decreased saving the space of the portable phone but also the user can increase the character input speed. Furthermore, compared with the conventional character input method, the input method provided by the present invention is more convenient.

FIG. 8 is a flow chart illustrating a character input method according to one embodiment of the present invention. As shown in FIG. 8, in S31, the method is started and then an editorial table (S81) of the communication main body is opened. The editorial table comprises a phone book, a schedule table and a short message table for the editorial operation. Further, by referring to the character to be selected by the user (S82), a corresponding key of the keypad is selected together with one of the keys of the arrow keypad (S83). Thereafter, at least one character is input into the editorial table according to the steps mentioned above (S84). Then, the input operation is rapidly finished(S85). Finally, in S37, the character input operation is terminated.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A portable communication apparatus, comprising:
a communication main body;
a keypad having at least one key disposed on the communication main body;
an arrow keypad having keys and disposed on the communication main body, wherein various characters are represented respectively by combinations of the at least one key of the keypad with the keys of the arrow keypad, and input of each of the characters into the communication apparatus is performed by depressing the at least one key and then one of the keys of the arrow keypad; and
a display screen on the communication main body.

2. The portable communication apparatus of claim 1, wherein the characters include letters of an alphabet.

3. The portable communication apparatus of claim 1, wherein the arrow keypad comprises a central key and four arrow keys.

4. The portable communication apparatus of claim 3, wherein the four arrow keys are directed in different directions, depressing the at least one key effects a radial menu shown on the display screen, and the radial menu includes a central item, represented by the central key, and four items located respectively along the different directions away from the central item.

5. The portable communication apparatus of claim 1, wherein the combinations of the at least one key of the keypad with the keys of the arrow keypad are arranged according to a built-in correspondence table mapping the characters to the combinations.

6. A character input method for a portable communication apparatus having a keypad and an arrow keypad disposed on the communication apparatus, the keypad having at least one key and the arrow keypad having keys, the method comprising:
depressing the at least one key of the keypad to effect a menu, shown on the communication apparatus, including items represented by the keys of the arrow keypad; and
depressing one of the keys of the arrow keypad to select and input one of the items as a character into an editorial table of the portable communication apparatus.

7. The method of claim 6, wherein the character is a letter of an alphabet.

8. The method of claim 6, wherein various characters are represented respectively by combinations of the at least one key of the keypad with the keys of the arrow keypad.

9. The method of claim 8, wherein the combinations of the at least one key of the keypad with the keys of the arrow keypad are arranged according to a built-in correspondence table mapping the characters to the combinations.
